(19) United States
(12) Patent Application Publication
(10) Pub. No.: US 2006/0022519 A1
(43) Pub. Date: Feb. 2, 2006

(54) Method for controlling regenerative braking of a belt-driven hybrid vehicle

(76) Inventors: Sang Woo Ji, Hwaseong-city (KR); Sang Hyun Jang, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/244,260

(22) Filed: Oct. 5, 2005

(30) Foreign Application Priority Data
May 10, 2004 (KR) 10-2004-0079006

(51) Int. Cl. B60T 8/64

(52) U.S. Cl. 303/152

(57) ABSTRACT

A method and system for controlling regenerative braking of a belt-driven hybrid vehicle includes detecting a battery state of charge, calculating a required charging current on the basis of the battery state of charge, calculating a theoretical regenerative braking torque on the basis of the required charging current, calculating a target regenerative braking torque by compensating the theoretical regenerative braking torque depending on a change of belt temperature, and performing regenerative braking control on the basis of the target regenerative braking torque.

### CROSS-REFERENCE TO RELATED APPLICATION

This application claims priority to and the benefit of Korean Patent Application No. 10-2004-0079006 filed in the Korean Intellectual Property Office on Oct. 5, 2004, the entire contents of which are incorporated herein by reference.

### BACKGROUND OF THE INVENTION

(a) Field of the Invention

The present invention relates to a method and system for controlling regenerative braking of a belt-driven hybrid vehicle.

(b) Description of the Related Art

Generally, a belt-driven hybrid vehicle has an idle stop (engine off) function (as does a typical hybrid vehicle), which improves fuel consumption efficiency. Here, the term “belt-driven vehicle” means a vehicle in which energy (power) is delivered between an ISG (integrated starter-generator) and an engine through a belt. The idle stop function improves fuel efficiency by approximately 15% in congested city driving. Generally, when an Idle Stop & Go function is performed in the vehicle, a battery of the vehicle consumes electrical energy. Therefore, it is required to charge the battery while driving.

For charging the battery of a running vehicle, regenerative braking can be used. Regenerative braking can change kinetic energy (generated by engine braking or deceleration) to electrical energy. However, in conventional methods for controlling regenerative braking of a belt-driven hybrid vehicle, characteristics of belts and other driving conditions are not considered sufficiently.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide methods for controlling regenerative braking of a belt-driven hybrid vehicle having advantages of improving efficiency of regenerative braking and generating efficiency of a charging current.

An exemplary method for controlling regenerative braking of a belt-driven hybrid vehicle according to one embodiment of the present invention includes detecting a battery state of charge (SOC), calculating a required charging current on the basis of the battery state of charge, calculating a theoretical regenerative braking torque on the basis of the required charging current, calculating a target regenerative braking torque by compensating the theoretical regenerative braking torque depending on a change of belt temperature, and performing regenerative braking control on the basis of the target regenerative braking torque.

The performing of regenerative braking control on the basis of the target regenerative braking torque may include calculating a current regenerative braking torque on the basis of parameters including vehicle deceleration and a master cylinder operation force, and performing regenerative braking control such that the current regenerative braking torque approaches the target regenerative braking torque.

The calculating of the target regenerative braking torque may include determining a belt temperature, determining a belt temperature constant on the basis of the belt temperature, and calculating the target regenerative braking torque by compensating the theoretical regenerative braking torque on the basis of the belt temperature constant, wherein the belt temperature constant is used for compensating the theoretical regenerative braking torque such that the target regenerative braking torque becomes lager than the theoretical regenerative braking torque when the belt temperature is higher than a predetermined temperature.

The determining of the belt temperature may include measuring a temperature near a crankshaft, and estimating the belt temperature on the basis of the temperature near the crankshaft.

The determining of the current regenerative braking torque may include determining whether an accelerator is operated, determining whether the brake is operated when the accelerator is not operated, detecting vehicle deceleration when the brake is operated, calculating a total braking force on the basis of the vehicle deceleration, calculating a brake operation force of the wheels on the basis of the master cylinder operation force, and calculating the current regenerative braking torque on the basis of the total braking force and the brake operation force of the wheels.

The performing of the regenerative braking control on the basis of the target regenerative braking torque may include determining whether an accelerator is operated or not, determining whether the brake is operated or not when the accelerator is not operated, detecting vehicle deceleration when the brake is not operated, detecting a crankshaft RPM when a vehicle is under deceleration, and performing regenerative braking when the crankshaft rotation speed is higher than a predetermined lower limit rotation speed.

It is determined to stop the regenerative braking when the vehicle velocity is lower than a predetermined limit velocity, a motor rotation speed is lower than a predetermined limit rotation speed, and an engine idle RPM is lower than a predetermined limit engine RPM.

When it is determined to stop the regenerative braking, the regenerative braking is stopped, and the vehicle deceleration and the vehicle velocity or crankshaft rpm are detected and anti-fishtail control is performed when the vehicle velocity or the crankshaft RPM is maintained over a predetermined lower limit.

In a further exemplary embodiment of the present invention, a system for controlling regenerative braking of a belt-driven hybrid vehicle includes an engine for providing driving power to wheels of a vehicle, an integrated starter-generator (ISG) cooperating with the engine through a drive belt, at least one battery supplying power to the ISG; sensors for outputting signals indicative of at least a state of charge of the battery and a temperature of the drive belt; and a control portion controlling operation of the ISG at least in part in response to the signals from said sensors.

The control portion preferably includes processing means programmed to execute instructions for calculating a required charging current on the basis of the battery state of charge, calculating a theoretical regenerative braking torque on the basis of the required charging current, calculating a target regenerative braking torque by compensating the theoretical regenerative braking torque depending on a change of the belt temperature, and performing regenerative braking control on the basis of the target regenerative braking torque.

In a further exemplary embodiment, the system may additionally comprise sensors for generating signals indicative of vehicle deceleration and master cylinder operation force

### BRIEF DESCRIPTION OF THE DRAWINGS

FIG. 1A and FIG. 1B are drawings of a schematic structure of a belt-driven hybrid vehicle.

FIG. 2A to FIG. 2C are flow charts of an exemplary embodiment of a method for controlling regenerative braking of a belt-driven hybrid vehicle according to the present invention.

FIG. 3 is a graph showing a correlation of a crankshaft temperature, a belt temperature, and a belt temperature constant.

### DETAILED DESCRIPTION OF THE EMBODIMENTS

Exemplary embodiments of the present invention will hereinafter be described in detail with reference to the accompanying drawings.

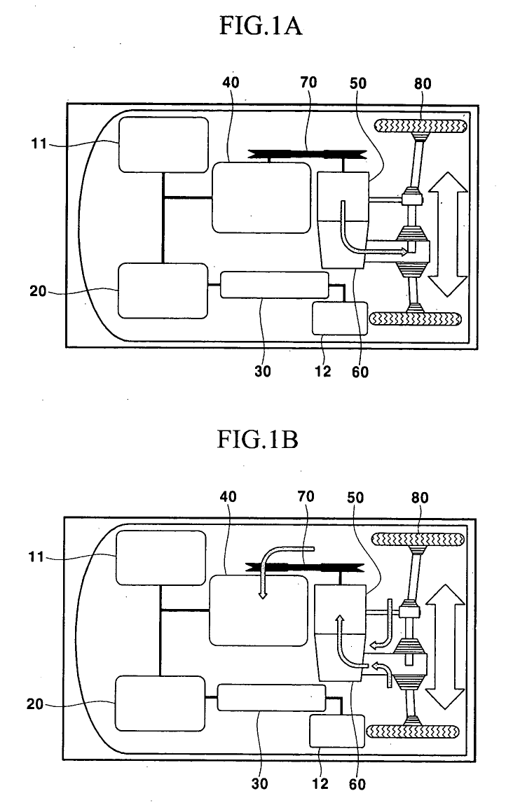

An exemplary embodiment of the present invention will be described with reference to the 42V belt-driven hybrid vehicle, but it is not limited thereto. For example as shown in FIG. 1A and FIG. 1B, a vehicle has a 36V battery and BMS (Battery Management System) 11, a 12V battery 12, an ISG (integrated starter-generator) 40, an engine 50, a transmission 60, a DC/DC converter 30, wheels 80, and a control portion 20 for controlling the system. According to FIG. 1A, when a vehicle runs, driving force of the engine 50 is delivered to the wheels 80. According to FIG. 1B, when regenerative braking is performed, force is delivered from the wheels 80 to the ISG 40. The power is delivered between the ISG 40 and the engine 50 through the belt 70, and the amount of energy being delivered by the belt changes according to a change of belt temperature.

Regenerative braking recovers energy generated when running a vehicle, as electrical energy. Factors that influence regenerative braking include the battery state of charge (SOC), vehicle velocity (Vcar), motor torque, crankshaft rotation speed, vehicle deceleration (DEC), master cylinder operation force, the required charging current (Ireq), the grade of the vehicle (Gd), the belt temperature constant (K), and the gear state. These factors may be sensed using appropriate sensors as may be selected by persons of ordinary skill in the art and which may be integrated as appropriate into the components shown in FIGS. 1A and 1B.

The present exemplary embodiment of the present invention relates to a method for controlling regenerative braking of a belt-driven hybrid vehicle considering a general running state and a regenerative braking state. In the general running state, the power from the engine is delivered to the wheels through a transmission, and in a regenerative braking state, the kinetic energy of the vehicle is delivered from the wheels to an ISG through the transmission, a crankshaft, and the belt as described above.

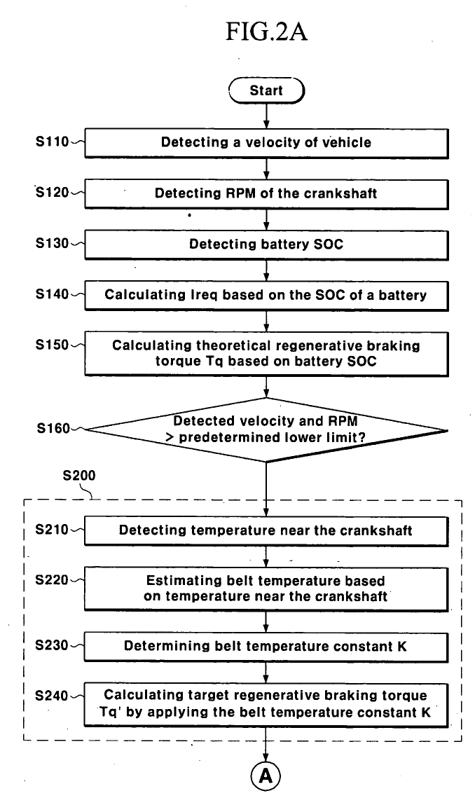

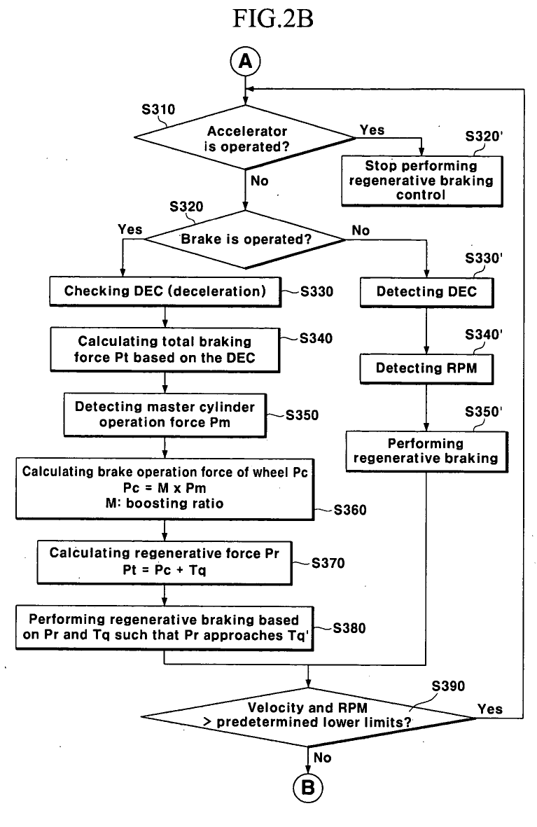

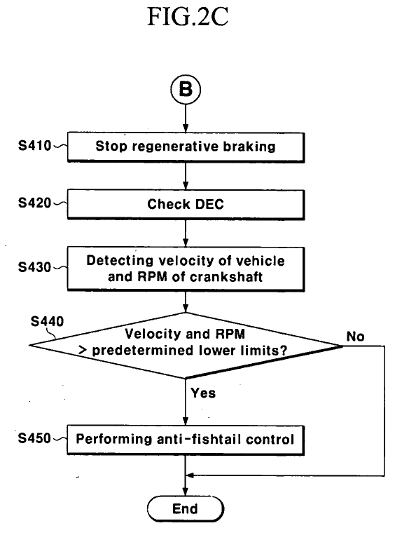

With particular reference to FIG. 2A to FIG. 2C, a method for controlling regenerative braking considering characteristics of a belt will be described.

Firstly, at step S110, a vehicle velocity (km/h) is detected.

Then, at step S120, a crankshaft rotation speed (RPM) is detected.

The battery SOC (state of charge) is then detected by a control portion at step S130.

Here, an electronic control unit (ECU) may be used as the control portion 20. The ECU may comprise a processor, memory and associated software, hardware and/or firmware as may be selected and programmed by a person of ordinary skill in the art based on the teachings contained herein.

The battery SOC is calculated as a lower value under the lower voltage, and on the other hand, it is calculated as a higher value under the higher voltage. The target battery SOC in the controlling of regenerative braking may be changed according to the design conditions of the vehicle.

When the battery voltage is 32V, the battery SOC may be 40%, and when the battery voltage is 38V, the battery SOC may be 95%. The desirable battery SOC may be 75%, but it is not limited thereto.

When the battery SOC is acquired, a required charging current Ireq is calculated on the basis of the SOC, the vehicle velocity, and the crankshaft rotation speed, at step S140.

The required charging current Ireq is that which is required to charge the battery.

When the required charging current is acquired, a theoretical braking torque Tq is calculated on the basis of the required charging current Ireq at step S150.

The theoretical regenerative braking torque Tq is a torque that must be generated by the motor while the vehicle runs in order to provide the required charging current.

Subsequently, at step S160, the detected vehicle velocity and crankshaft rotation speed are compared to predetermined lower limits of the vehicle velocity and crankshaft rotation speed.

If the detected vehicle velocity and crankshaft rotation speed are greater than the lower limits thereof, a target regenerative braking torque Tq′ is calculated by compensating the theoretical regenerative braking torque Tq, according to the change of belt temperature, at step S200.

If the engine rotation speed (RPM) is abruptly decreased, the operation of the engine may be unstable. Therefore, it is preferable that the regenerative braking is performed at over the predetermined lower limit of engine rotation speed. Here, the engine rotation speed is the rotation speed of the crankshaft. The lower limit of the engine rotation speed may be greater than 10% more than the idle RPM, and the lower limit fall within the range of 750-900 RPM.

To acquire the target regenerative braking torque, firstly, a temperature near the crankshaft is detected at step S210.

Then, at step S220, on the basis of the temperature near the crankshaft, the belt temperature is estimated.

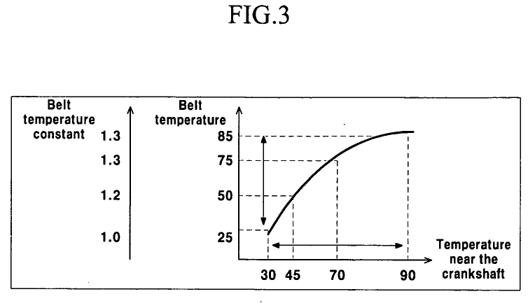

FIG. 3 shows a correlation of the temperature near the crankshaft, the belt temperature, and a belt temperature constant, acquired by experiments. Using the data in FIG. 3, the belt temperature can be estimated on the basis of the temperature near the crankshaft.

After the belt temperature is estimated, a belt temperature constant K is determined based on the estimated belt temperature at step S230, from the correlations of FIG. 3.

After the belt temperature constant K is determined, a target regenerative braking torque Tq′ is calculated by amending the theoretical regenerative braking torque Tq (which is acquired on the basis of the required change current Ireq), based on the belt temperature constant K, at step S240.

TABLE 1

| | | | | theoretical |
|---|---|---|---|---|
| | | | | regenerative |
| | | | theoretical | braking |
| | | belt | regenerative | torque |
| temperature | Belt | temperature | braking | increase/ |
| (° C.) | tension(N) | constant | torque | decrease |
| −25 | 734 | K1 1.0 | {20 Nm} | ±0% |
| 0 | 672 | ↑ | | ↑ |
| 25 | 611 | ↑ | | ↑ |
| 50 | 549 | K2 1.2 | | +0.2% |
| | | | | {24 Mm} |
| 75 | 513 | K3 1.3 | | +0.3% |
| 100 | 486 | ↑ | | {26 Nm} |

The preceding Table 1 shows the relationship between the belt tension, the belt temperature constant K, the theoretical regenerative braking torque, and the theoretical regenerative braking torque increase/decrease.

Generally, when the temperature rises, the belt is elongated. Therefore, the tension of the belt decreases and the belt slip ratio increases, which may cause an energy loss in the energy delivery between the crankshaft and the ISG.

That is, as the belt temperature increases, the energy delivered through the belt is reduced.

Therefore, to acquire the required charging current Ireq that is calculated at step S140, the torque loss in the delivery (when the belt temperature rises) must be compensated.

In the present exemplary embodiment of the invention, the belt temperature constant K is used for the torque compensation.

As shown in the above Table 1, as an example, when the belt temperature is 0° C. and the theoretical regenerative braking torque is 20 Nm, the increase or decrease of the theoretical regenerative braking torque is zero. Therefore, the belt temperature constant K is 1.

However, if the belt temperature becomes 50° C., energy loss would occur in the delivery due to the decrease of belt tension. Therefore, an energy loss of 4 Nm should be compensated such that the theoretical regenerative braking torque becomes 24 Nm. Then, the regenerative braking is performed.

When the belt temperature is 50° C., the belt temperature constant K of 1.2 is multiplied by the theoretical regenerative braking torque Tq acquired from the required charge current Ireq calculated in the step S140, to calculate a target regenerative braking torque Tq′.

When the belt temperature is over 75° C., the belt temperature constant K is 1.3.

After calculating the target regenerative braking torque Tq′ by compensating the theoretical regenerative braking torque Tq, regenerative braking is performed on the basis of the target regenerative braking torque Tq′.

Hereinafter, a step of performing regenerative braking control based on the target regenerative braking torque Tq′ will be described in detail.

Firstly, it is determined whether an accelerator is operated or not at step S310.

A control portion determines the operation state of the accelerator.

If the accelerator is not operated, it is detected whether the brake is operated or not at step S320.

On the other hand, if the accelerator is being operated, the regenerative braking control is stopped at step S320′.

The controlling process is stopped because the vehicle is determined to be in a running state in which regenerative braking is not performed.

In the above-mentioned S320 step, if the brake is operated, vehicle deceleration (DEC) is detected at step S330.

When vehicle deceleration is detected, total braking force Pt is calculated on the basis of the vehicle deceleration at step S340.

A master cylinder operation force Pm is detected at step S350.

When the master cylinder operation force Pm is detected, a brake operation force of a wheel Pc is acquired through the following Equation 1 at step S360.
Pc=M*Pm [Equation 1]
where M is a boosting ratio.

When the total braking force Pt and brake operation force Pc acquired, a current regenerative braking torque Pr is calculated through the following Equation 2.
Pt=Pc+Pr [Equation 2]

After the current regenerative braking torque Pr is calculated, regenerative braking is performed such that the current regenerative braking torque Pr approaches the calculated target regenerative braking torque Tq′ at step S380.

On the other hand, in step S320, if it is determined that the brake is not operated, vehicle deceleration DEC is checked at step S330′.

After checking the vehicle deceleration, if the vehicle is being decelerated, the rotation speed of the crankshaft is detected at step S340′.

If the rotation speed of crankshaft is higher than a predetermined lower limit, regenerative braking is performed at step S350′.

During the regenerative braking, it is determined whether the vehicle velocity and engine rotation speed RPM are under predetermined lower limits at step S390. If the vehicle velocity and engine rotation speed (RPM) are under the lower limits, it is determined to stop performing regenerative braking, on the basis of additional vehicle conditions at step S410.

For example, if the vehicle velocity is under the lower limit (15 km/h), the motor rotation speed is under the lower limit (2100 RPM), and the engine idle rotation speed (Idle RPM) is maintained as a predetermined speed (700 RPM), regenerative braking can be stopped.

If the regenerative braking is stopped, vehicle deceleration (DEC) is checked at step S420.

Then, if the vehicle is being decelerated, vehicle velocity and engine rpm are detected at step S430.

After the regenerative braking is stopped, it is determined whether the vehicle deceleration is maintained over a predetermined rate (predetermined lower limit deceleration) at step S440, and the vehicle velocity and engine rotation speed are maintained over a predetermined rotation speed (predetermined lower limit rotation speed).

When the vehicle deceleration is maintained at a predetermined rate, and vehicle velocity and the engine rotation speed decrease are maintained, anti-fishtail control is performed at step S450.

The anti-fishtail control is used for preventing the phenomenon that the rear part of the vehicle is lifted up like the tail of a fish when the vehicle is abruptly braked, causing the vehicle to loose traction at the rear. During the anti-fishtail control, the engine rotation speed is gradually decreased, so as to linearly control the vehicle velocity after finishing the regenerative braking.

On the other hand, in the step S390, if the condition for maintaining regenerative braking is satisfied, it is again determined whether the accelerator is operated or not at step S310.

During the regenerative braking according to the present invention, in addition to the above-mentioned conditions, the vehicle grade (Gd) or state of transmission, etc., can be reflected.

The control conditions used in the regenerative braking control can be reflected according to predetermined priorities, and the control conditions can be amended by experiment.

Exact amendments can be controlled by repetition of experiments.

According to the exemplary embodiment of the present invention, regenerative braking control performance can be improved, and efficiency of generating a charging current can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling regenerative braking of a belt-driven hybrid vehicle, comprising:
detecting a battery state of charge;
calculating a required charging current on the basis of the battery state of charge;
calculating a theoretical regenerative braking torque on the basis of the required charging current;
calculating a target regenerative braking torque by compensating the theoretical regenerative braking torque depending on a change of a belt temperature; and
performing regenerative braking control on the basis of the target regenerative braking torque.

2. The method of claim 1, wherein,
the performing of regenerative braking control on the basis of the target regenerative braking torque comprises:
calculating a current regenerative braking torque on the basis of parameters including vehicle deceleration and a master cylinder operation force; and
performing regenerative braking control such that the current regenerative braking torque approaches the target regenerative braking torque.

3. The method of claim 1, wherein
the calculating of the target regenerative braking torque comprises:
determining a belt temperature;
determining a belt temperature constant on the basis of the belt temperature; and
calculating the target regenerative braking torque by compensating the theoretical regenerative braking torque on the basis of the belt temperature constant,
wherein the belt temperature constant is used for compensating the theoretical regenerative braking torque, such that the target regenerative braking torque becomes larger than the theoretical regenerative braking torque when the belt temperature is higher than a predetermined temperature.

4. The method of claim 3, wherein
the determining of the belt temperature comprises:
measuring a temperature near a crankshaft; and
estimating the belt temperature on the basis of the temperature near the crankshaft.

5. The method of claim 2, wherein
the determining of the current regenerative braking torque comprises:
determining whether an accelerator is operated;
determining whether the brake is operated when the accelerator is not operated;
detecting vehicle deceleration when the brake is operated;
calculating a total braking force on the basis of the vehicle deceleration;
calculating a brake operation force of a wheel on the basis of the master cylinder operation force;
calculating the current regenerative braking torque on the basis of the total braking force and the brake operation force of the wheel.

6. The method of claim 1, wherein
the performing of regenerative braking control on the basis of the target regenerative braking torque comprises:
determining whether an accelerator is operated or not;
determining whether the brake is operated or not when the accelerator is not operated;
detecting vehicle deceleration when the brake is not operated;
detecting a crankshaft rotation speed when a vehicle is undergoing deceleration; and
performing regenerative braking when the crankshaft rotation speed is higher than a predetermined lower limit rotation speed.

7. The method of claim 1, further comprising
determining whether regenerative braking should be stopped, wherein
regenerative braking is stopped when the vehicle velocity is lower than a predetermined limit velocity, a motor rotation speed is lower than a predetermined limit rotation speed, an engine idle RPM is lower than a predetermined engine RPM.

8. The method of claim 1, further comprising
determining whether a condition for stopping regenerative braking is satisfied;
stopping regenerative braking when the condition for stopping the regenerative braking is satisfied;
detecting vehicle deceleration after stopping regenerative braking;
detecting a decrease in vehicle velocity and crankshaft rotation speed; and
performing anti-fishtail control while the vehicle velocity and the crankshaft rotation speed decrease are maintained over a predetermined lower limit.

9. A system for controlling regenerative braking of a belt-driven hybrid vehicle, comprising:
an engine for providing driving power to wheels of a vehicle;
an integrated starter-generator (ISG) cooperating with the engine through a drive belt;
at least one battery supplying power to the ISG;
sensors for outputting signals indicative of at least a state of charge of the battery and a temperature of the drive belt;
a control portion controlling operation of the ISG at least in part in response to the signals from said sensors, the control portion including processing means programmed to execute instructions comprising:
calculating a required charging current on the basis of the battery state of charge;
calculating a theoretical regenerative braking torque on the basis of the required charging current;
calculating a target regenerative braking torque by compensating the theoretical regenerative braking torque depending on a change of the belt temperature; and
performing regenerative braking control on the basis of the target regenerative braking torque.

10. The system of claim 9, further comprising sensors for generating signals indicative of vehicle deceleration and master cylinder operation force, wherein said performing of regenerative braking control comprises additional instructions programmed for execution by the control portion, said additional instructions comprising:
calculating a current regenerative braking torque on the basis said signals indicative of vehicle deceleration and master cylinder operation force; and
performing regenerative braking control such that the current regenerative braking torque approaches the target regenerative braking torque.

11. The system of claim 9, wherein said instruction for calculating of the target regenerative braking torque comprises:
determining a belt temperature constant on the basis the signal indicative of belt temperature; and
calculating the target regenerative braking torque by compensating the theoretical regenerative braking torque on the basis of the belt temperature constant,
wherein the belt temperature constant is used for compensating the theoretical regenerative braking torque, such that the target regenerative braking torque becomes larger than the theoretical regenerative braking torque when the sensed belt temperature is higher than a predetermined temperature.

12. The system of claim 10, wherein the instruction for determining of the current regenerative braking torque comprises instructions for:
determining whether an accelerator is operated;
determining whether the brake is operated when the accelerator is not operated;
detecting vehicle deceleration when the brake is operated;
calculating a total braking force on the basis of the vehicle deceleration;
calculating a brake operation force of a wheel on the basis of the master cylinder operation force;
calculating the current regenerative braking torque on the basis of the total braking force and the brake operation force of the wheel.

13. The system of claim 9, wherein the instruction for
performing regenerative braking control comprises instructions for:
determining whether an accelerator is operated or not;
determining whether the brake is operated or not when the accelerator is not operated;
detecting vehicle deceleration when the brake is not operated;
detecting a crankshaft rotation speed when a vehicle is undergoing deceleration; and
performing regenerative braking when the crankshaft rotation speed is higher than a predetermined lower limit rotation speed.

14. The system of claim 9, wherein said processing means is programmed to execute further instructions comprising:
determining whether regenerative braking should be stopped, wherein
regenerative braking is stopped when the vehicle velocity is lower than a predetermined limit velocity, a motor rotation speed is lower than a predetermined limit rotation speed, an engine idle RPM is lower than a predetermined engine RPM.

15. The system of claim 1, wherein said processing means is programmed to execute further instructions comprising:
determining whether a condition for stopping regenerative braking is satisfied;
stopping regenerative braking when the condition for stopping the regenerative braking is satisfied;
detecting vehicle deceleration after stopping regenerative braking;
detecting a decrease in vehicle velocity and crankshaft rotation speed; and
performing anti-fishtail control while the vehicle velocity and the crankshaft rotation speed decrease are maintained over a predetermined lower limit.
